(19) United States
(12) Patent Application Publication
(10) Pub. No.: US 2010/0250815 A1
(43) Pub. Date: Sep. 30, 2010

(54) PORTABLE DOCKING CRADLE

(75) Inventors: Louis Street, Avon (GB); Mark Rees, Avon (GB)

Correspondence Address: DINSMORE & SHOHL LLP, FIFTH THIRD CENTER, ONE SOUTH MAIN STREET, SUITE 1300, DAYTON, OH, 45402-2023, US

(73) Assignee: Armoured Technology Developments Limited

(21) Appl. No.: 12/377,925

(22) PCT Filed: Jul. 25, 2007
(86) PCT No.: PCT/GB07/02817

§ 371 Date: Feb. 18, 2009

(30) Foreign Application Priority Data
Jul. 25, 2006 (GB) 0614770.6
Aug. 16, 2006 (GB) 0616292.9
Aug. 30, 2006 (GB) 0617091.4
May 18, 2007 (GB) 0709602.7

(51) Int. Cl. G06F 13/00

(52) U.S. Cl. 710/303

(57) ABSTRACT

A portable protective docking cradle engageable with an electronic display device which comprises an interface enabling data communication with the device, and control elements for operating the device via the interface. The cradle is shaped to embrace the device in a docking bay, the docking bay being defined by arms of the cradle that are spaced to enable viewing of a display of the device.

The invention relates to a docking cradle for a display unit such as a navigation display or a tablet computer. In particular, the invention relates to a docking cradle for use outdoors, for example, in a marine environment.

Electronic equipment is often used outdoors, for example, in military applications, in the industries of surveying and construction, and in conservation. When used outdoors, such equipment should be protected against damage due to exposure to the elements. Protection is typically provided on an improvised and unsatisfactory basis by placing the equipment in a clear plastic bag or covering it with a user's coat, for example.

Furthermore, in order to carry out tasks outdoors, it is often necessary to use the electronic equipment while on the move in a vehicle such as a car or boat. Of course, using such equipment in these environments exposes the equipment to a risk of damage resulting from a fall or collision.

Considering that electronic equipment used in the above sectors may be highly specialised and therefore expensive, and as it may be several days before data stored in the equipment can be backed-up, there is a need to ensure that the equipment is safe.

Another issue is the difficulty of operating electronic equipment in outdoor environments, especially where the environment is cold, dark and wet. In these circumstances, it may be difficult to hold an item of electronic equipment and press its keys, buttons or other control elements, especially when wearing gloves.

The present invention seeks to minimise the likelihood of damage to electronic equipment used outdoors and in vehicles, and to provide an apparatus to allow electronic equipment to be used conveniently in outdoor environments.

Against this background, the present invention resides in a portable protective docking cradle engageable with an electronic display device, the cradle comprising an interface enabling data communication with the device; and control elements for operating the device via the interface; wherein the cradle is shaped to embrace the device in a docking bay, the docking bay being defined by arms of the cradle that are spaced to enable viewing of a display of the device.

Advantageously, the invention provides a cradle which is capable of protecting an electronic device in outdoor environments, while enabling the device to be conveniently and easily operated. The cradle also embraces the device, thus protecting the device in the event of a collision.

Preferably, the arms are joined by a base, and the arms and the base may define a U-shaped docking bay. In a preferred embodiment, the arms extend substantially orthogonally from the base. To enable the cradle to cooperate with the device, in a preferred embodiment, the base comprises at least one electrical connector facing the docking bay for engagement with a complementary connector of the device to create the interface.

The arms and the base may be in a substantially coplanar relation. The base may also comprise a lower retaining member for retaining the device in the docking bay. Preferably, the lower retaining member is a flange that extends upwardly from the base, and the flange may additionally comprise at least one recess for enabling access to one or more control elements of the device when the device is engaged with the cradle.

For further convenience, data communication between the cradle and the device is preferably wireless.

Opposed inner faces of the arms may be mutually parallel, and the inner faces may have formations for sliding engagement with opposed edges of the device.

In a preferred embodiment of the invention, the cradle comprises securing means for securing the device in the docking bay. The securing means may comprise a strap which spans the arms of the cradle, may extend across a top face of the device when the device is engaged with the cradle and may be cooperable with first and second lateral members positioned on the arms of the cradle. The strap can also be used as a handle or carry-strap, if required.

The strap may be secured with a ladderlock. Advantageously, the effectiveness of the strap and ladderlock is not reduced by exposure outdoors, in particular, to a marine environment. Alternatively, the strap may be secured with a hook and loop fastener. Typically, hook and loop fasteners enjoy a low risk of damage due to collision when used in the present invention. This is due to the loads involved being absorbed due to the fastener's fixing points.

The cradle may comprise a screen which is arranged in register with the display of the device when the device is engaged with the cradle. In a preferred embodiment, the screen is compatible with night vision goggles, and may be arranged to filter light from the display. The screen may be polarised to reduce glare from the screen when the screen is subjected to direct sunlight. Preferably, the screen is slidable relative to the cradle into register with the display.

In a further embodiment, the cradle comprises a protective cover which may comprise a connecting member engageable with the cradle, and the connecting member may be engageable with at least one edge of the cradle. Preferably, the connecting member and the at least one edge of the cradle engage to form a hinge. The protective cover may comprise fixing means to fix the cover to the cradle, and may comprise impact cushioning material. The impact cushioning material may be arranged along a top face of the cradle, and may comprise impact absorbing foam.

The arms of the cradle preferably comprise at least one supporting formation for supporting the device in the docking bay. Preferably, the arms comprise a side retaining arrangement for retaining the device in the docking bay. The side retaining arrangement preferably extends from at least one inside face of the arms of the cradle, and may comprise at least one flange.

The cradle may further comprise ports for enabling external communication with, and delivery of power to, the device. The control elements may comprise one or more soft key buttons, the function of which is selectable. In a preferred embodiment, the control elements comprise a cursor control pad. Preferably, the control elements are positioned adjacent to the display of the device when the display is engaged with the cradle, and may be positioned on the arms of the cradle. For ease of fabrication, at least some of the control elements are preferably fabricated as a strip.

The cradle may further comprise grip formations, which may be provided on the arms. The grip formations may comprise at least one plurality of concave recesses arranged in series, and the grip formations may be arranged on the outermost sides of the arms so that a user of the cradle may securely grip the cradle. Preferably, the grip formations are heated.

Preferably, the cradle further comprises an internal power supply which adds to the portability of the cradle and may be used as an emergency or auxiliary power source.

According to a further aspect, the invention also resides in a combination of an electronic display device and a docking cradle as described above. Preferably, the device is substantially cuboidal, and the cradle may have grip formations, wherein the grip formations are arranged adjacent to side faces of the device.

In a preferred embodiment of the combination, the side edges of the device are slidingly engageable with the arms. Preferably, the electronic display device and the docking cradle comprise at least one tongue and groove to enable sliding engagement.

In a further embodiment of the combination, where the cradle has a base, a further edge of the device comprises at least one electrical connector engageable with a complementary connector of the base.

The electronic device may be a laptop computer and/or a tablet computer.

According to a further aspect, the invention resides in a vehicle in which a portable docking cradle, as described above, or a combination, as described above, is mounted.

In order that this invention may be more readily understood, reference will now be made, by way of example, to the accompanying drawings in which:

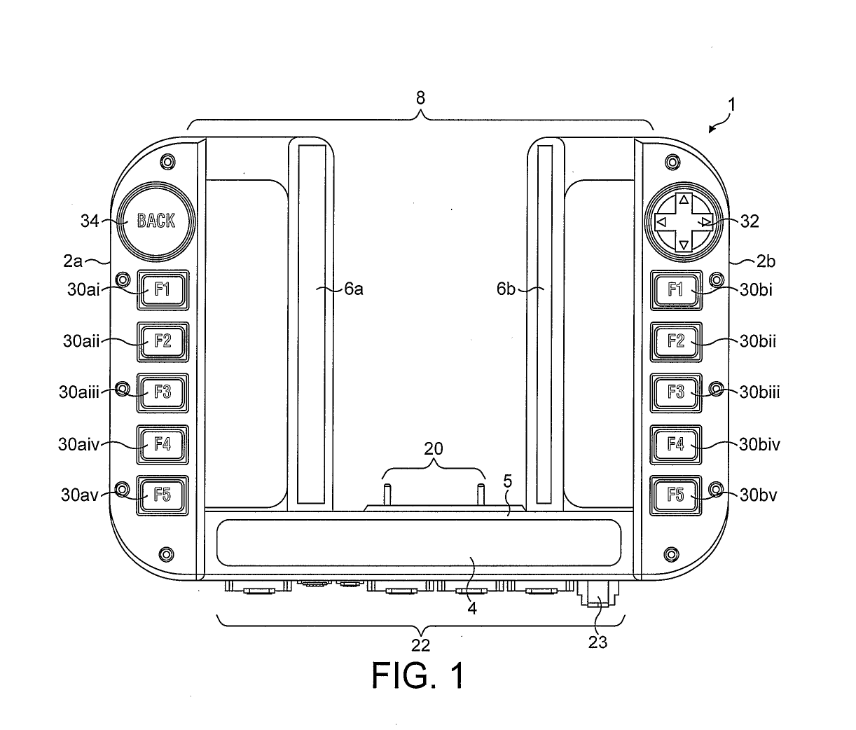

FIG. 1 is a front view of a docking cradle according to a first embodiment of the invention;

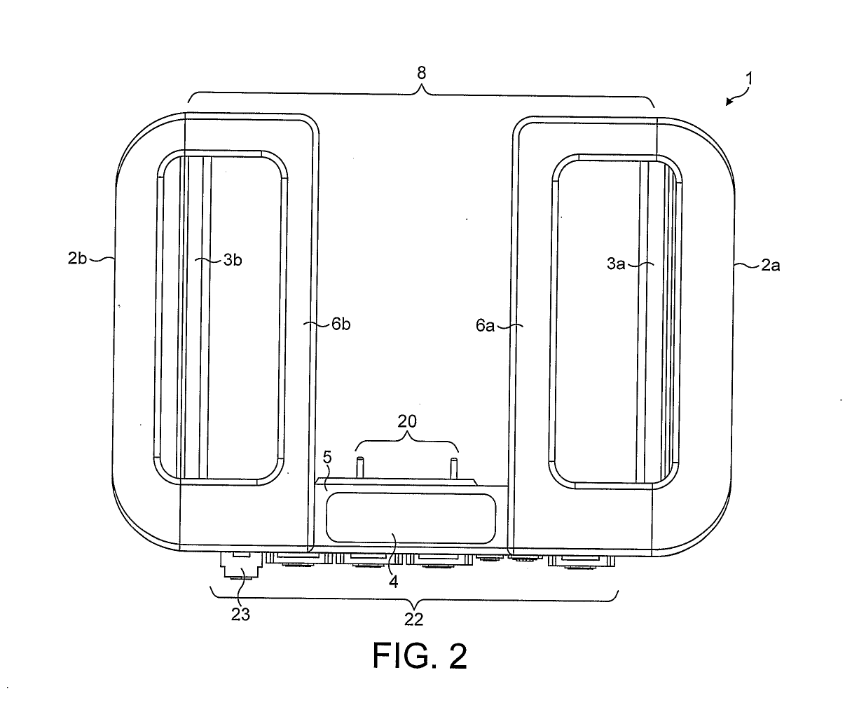

FIG. 2 is a rear view of the docking cradle of FIG. 1;

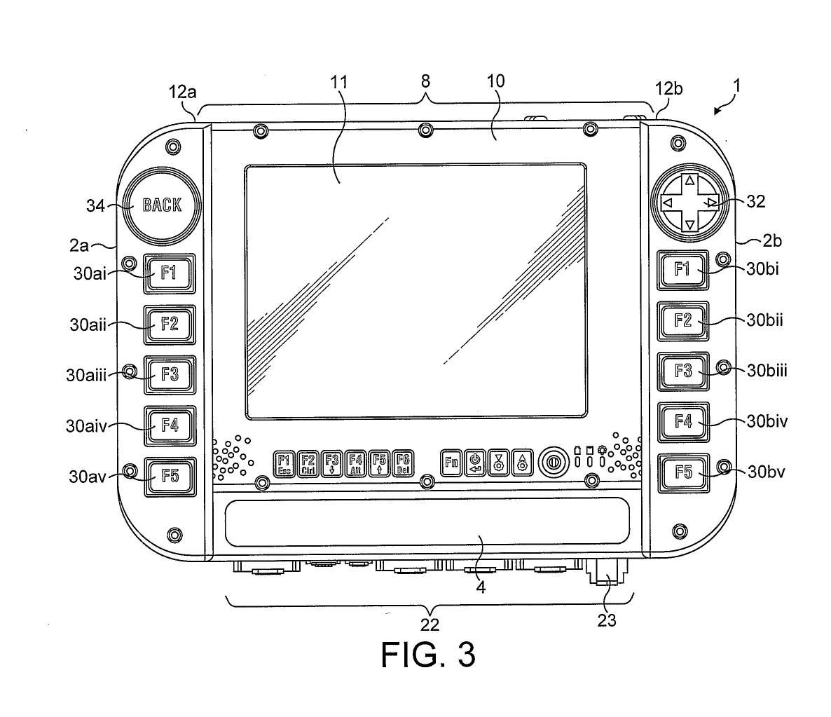

FIG. 3 is a front view of a multi-function display unit engaged with the docking cradle of FIG. 1;

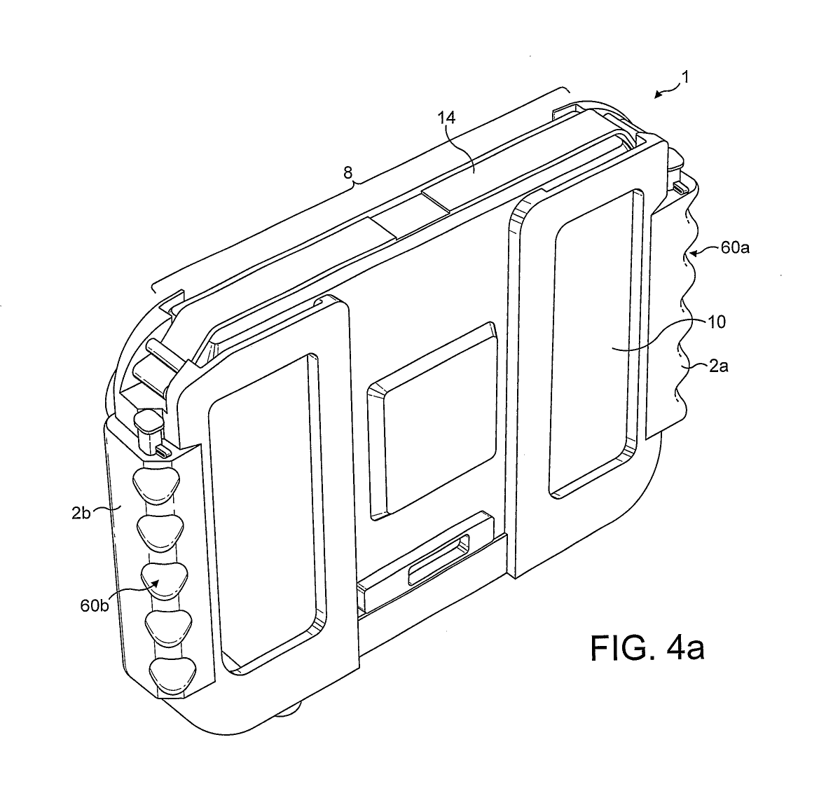

FIG. 4a is a rear perspective view from the side and above of the display unit secured in the docking cradle;

FIG. 4b is an enlarged detailed perspective view of a part of the assembly shown in FIG. 4a;

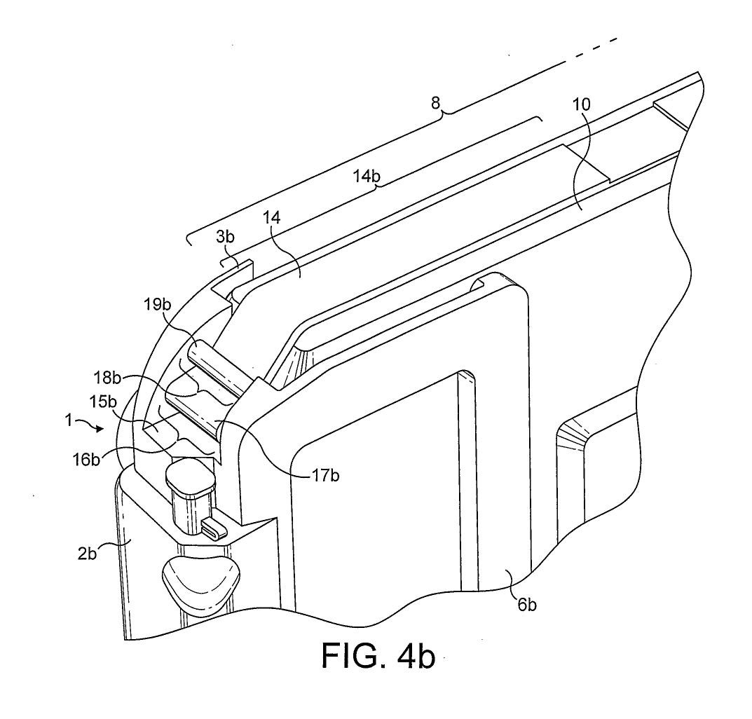

FIG. 5 is a schematic front view of a second embodiment of the invention which shows a transparent viewing panel being inserted into the front of the docking cradle;

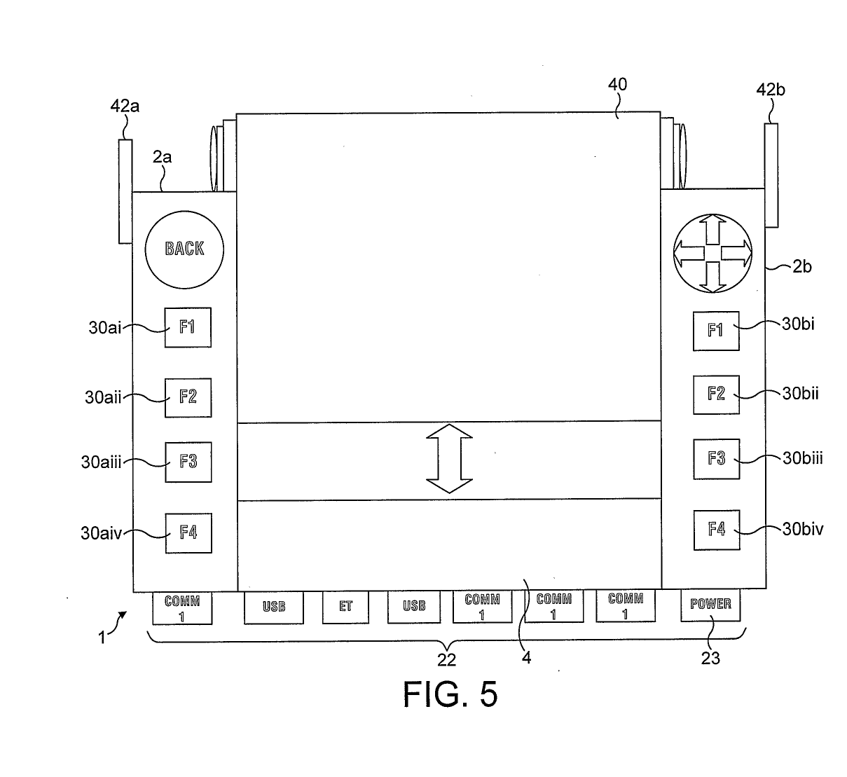

FIG. 6 corresponds to FIG. 5 but shows a cover engaged with the docking cradle, the cover having impact cushioning;

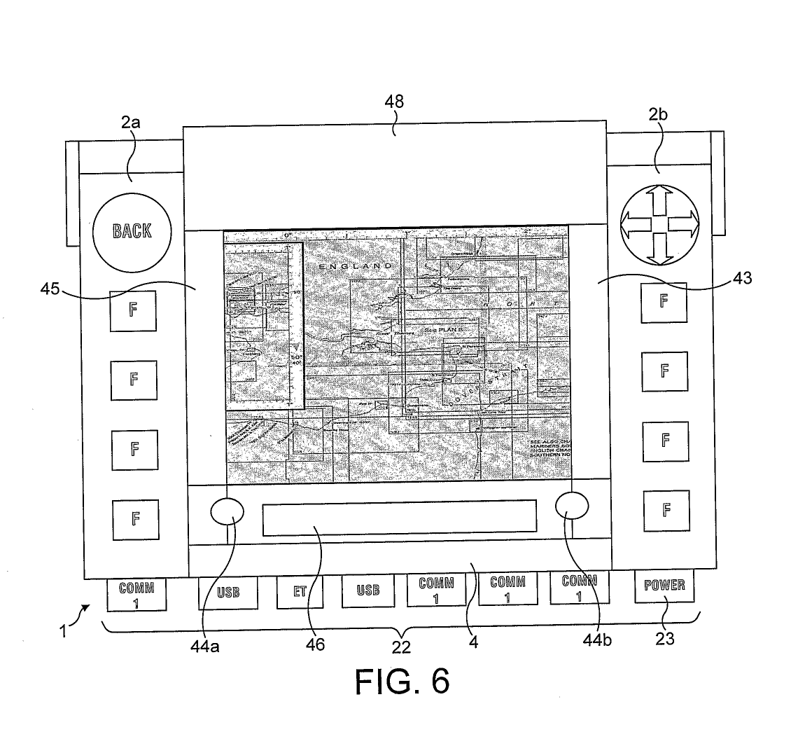

FIG. 7 is an exploded side view of the cover and docking cradle of FIG. 6, in an open position;

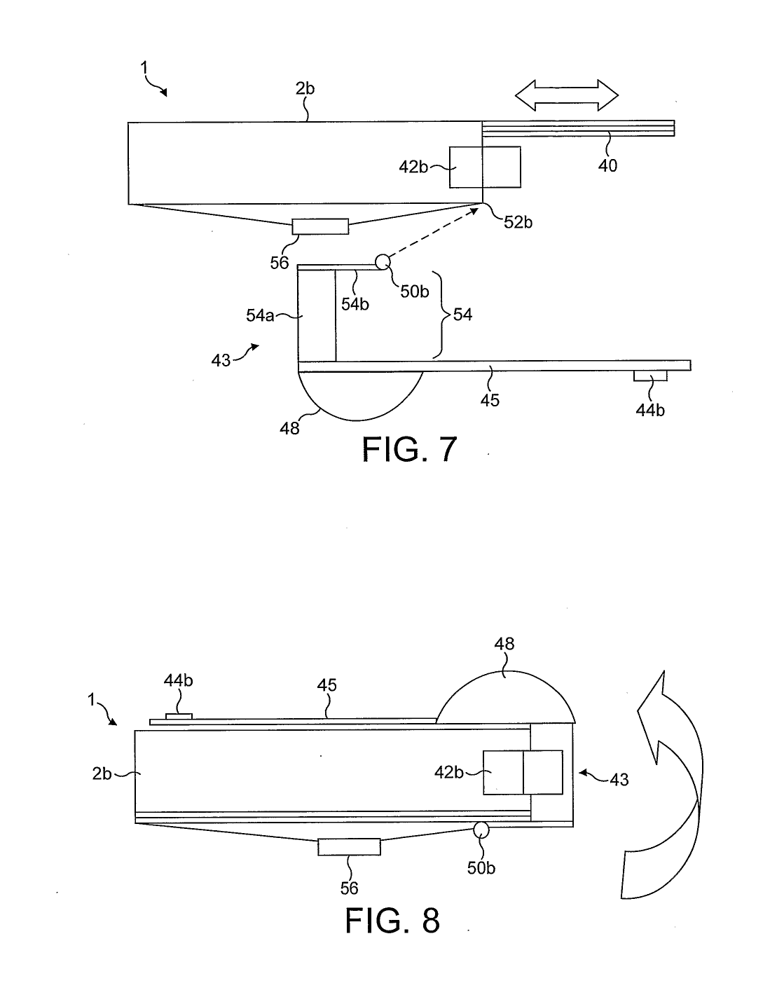

FIG. 8 is a side view corresponding to FIG. 7 but showing the cover and docking cradle in a closed position; and

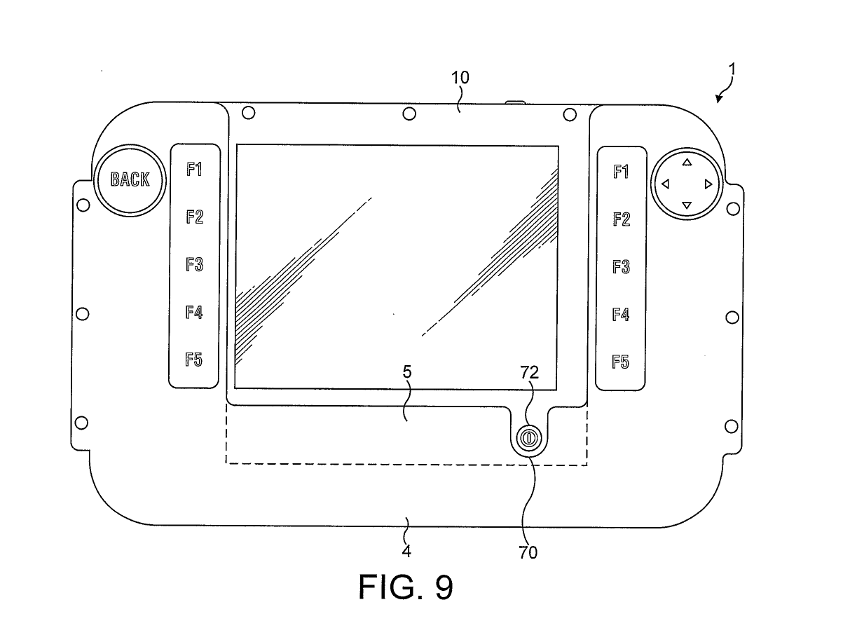

FIG. 9 is a front view of a third embodiment of the invention.

A docking cradle 1 is shown in FIGS. 1 and 2. The docking cradle 1 is generally U-shaped, comprising a first arm 2a and a second arm 2b, and a base 4. The arms 2a, 2b and the base 4 of the U are each substantially straight. The arms 2a, 2b extend in parallel from, and orthogonally with respect to, respective ends of the base 4. As can be seen most clearly in FIG. 2, the arms 2a, 2b of the docking cradle 1 are shaped with respective first and second supporting formations 6a, 6b which extend inwardly from the rear of the arms 2a, 2b. The arms 2a, 2b each have a respective first and second flange 3a, 3b which extend inwardly from the front of the arms 2a, 2b, and the base 4 has a base flange 5 which extends inwardly from the front of the base 4.

The base 4, arms 2a, 2b, flanges 3a, 3b, base flange 5 and supporting formations 6a, 6b define a bay 8 into which an oblong multi-function display unit 10 may be engaged and snugly supported by the docking cradle 1, as shown in FIG. 3. The inner faces of the arms 2a, 2b which, respectively, oppose first and second side faces 12a, 12b of the display unit 10 are shaped with interface formations such as one or more grooves (not shown) which are adapted to engage with complementary interface formations such as one or more corresponding tongues (not shown) on the first and second side faces 12a, 12b of the display unit 10. The or each combination of tongues and grooves allow sliding movement of the display unit 10 between and parallel to the arms 2a, 2b into full engagement with the docking cradle 1 in the bay 8.

When the display unit 10 is fully engaged in the bay 8, the unit 10 is secured in the bay 8 by a hook-and-loop fastener strap 14, as shown in FIG. 4a. Each arm 2a, 2b has a pair of parallel bars 17a, 19a, 17b, 19b for use with the strap 14. This is described in more detail with reference to FIG. 4b which is a close-up view of the top of the second arm 2b with the display unit 10 secured by the strap 14 using a first bar 17b and a second bar 19b. The parallel bars 17a and 19a associated with the first arm 2a are not shown in the accompanying drawings.

The strap 14 extends across the top edge of the display unit 10 and through a gap 16b defined between an upper edge 15b of the second arm 2b and the first bar 17b. The second bar 19b is situated above and slightly inward of the first bar 17b. The first and second bars 17b, 19b extend orthogonally between the front and rear faces of the docking cradle 1. The strap 14 loops around the first bar 17b and through a gap 18b between the first and second bars 17b, 19b, and is arranged so that the hook and loop components of the strap 14 are on opposite and opposed faces of the strap 14 in a contact area 14b.

The strap 14 also extends in the opposite direction across the top edge of the display unit 10 and engages with further gaps 16a, 18a (not shown) and corresponding bars 17a, 19a (not shown) at an upper edge 15a (not shown) of the first arm 2a in a manner identical to that described above. Reference numerals of the further gaps 16a, 16b, corresponding bars 17a, 19a and upper edge 15a are included so their equivalence is clear to the reader.

Other securing means such as locking bolts, quick-release water-resistant catches, strap and ladder locks or spring clips 42a, 42b (examples of which are illustrated in FIGS. 5 to 8) can be used instead of hook and loop fasteners.

When the display unit 10 is fully engaged in the bay 8, a docking port (not shown) in a bottom face of the display unit 10 connects to a corresponding opposed interface 20 located on the base 4 and extending into the bay 8, shown in FIGS. 1 and 2. This provides power from the cradle 1 to the unit 10 when the unit 10 is not being run on its internal power and facilitates data communication between the unit 10 and cradle 1, and for onward data connections with and to peripheral devices (not shown). For this purpose, the docking cradle 1 has port replicator functionality to extend the connectivity of the display unit 10 via communication ports 22, shown in FIGS. 1, 2, 3, 5 and 6, disposed along the lower edge of the base 4. The communication ports 22 are accompanied by a power socket 23 to convey power via the docking cradle 1 to the display unit 10.

Communication between the display 10 and a docking cradle according to an alternative embodiment of the invention (not shown) takes place via wireless technology. For example, Bluetooth®, infrared, Wi-Fi or other wireless protocols can be used.

The docking cradle 1 of the invention allows not only greater flexibility in what can be connected to the display unit 10 but also helps a user to control the display unit 10 and any applications it runs. Control of the display unit 10 is effected via first and second sets of soft key buttons 30ai to 30av, 30bi to 30bv mounted beside the display unit 10 on the front of the first and second arms 2a, 2b respectively. The soft key buttons 30ai to 30av, 30bi to 30bv allow the user to shortcut to essential functions implemented in software running on the display unit 10.

The first and second sets of soft key buttons 30ai to 30av, 30bi to 30bv are adjacent to options displayed as words or icons on a monitor 11 of the display unit 10, similarly to the system used on automated teller machines, for example. Therefore, the function of each button is able to change according to the information displayed on the screen, in the manner of a soft key.

A back button 34 is situated at the top of the front face of the first arm 2a to return quickly through menus presented on the monitor 11 of the display unit 10. Cursor control of the display unit 10 is effected by a directional-pad (D-pad) 32 gaming-style thumb control situated at the top of the front face of the second arm 2b.

The buttons and other controls of the docking cradle are manufactured from durable sealed rubber for weatherproofing and robustness. The docking cradle 10 may therefore be adapted for use primarily outdoors where it may be subjected to the elements, or salt water in a marine applications. Accordingly, the docking cradle 10 conforms to ingress protection rating IP54.

Each set of buttons 30ai to 30av, 30bi to 30bv is fabricated as a strip in order to resist the ingress of sand, moisture or other contaminants into the cradle 1. Other button arrangements are, of course, possible.

The front of the docking cradle 1 is arranged to allow a screen 40 to slide into register with the bay 8 via a watertight seal fitted to the front of the inner edges of the first and second arms 2a, 2b and the base 4, as illustrated in a second embodiment of the invention shown in FIG. 5. The reference numerals for features which are common to the embodiments described in this specification are the same in each embodiment in which they appear.

The screen 40 may simply be a transparent viewing panel which protects the front of the display unit 10. Alternatively, the screen 40 may have other properties which allows the monitor 11 of the display unit 10 to be read in direct sunlight or while the user is wearing night vision goggles. The screen 40 is locked into position with a protective cover 43, as shown in FIG. 6.

The protective cover 43 shown in FIGS. 6, 7 and 8 has first and second hinges 50a, 50b which are engageable with first and second rear top edges 52a, 52b (the first hinge 50a and first rear top edge 52a are not shown) of the first and second arms 2a, 2b respectively. The cover 43 comprises a flexible protective shield 45 of, for example, polyurethane, and first and second lockable press studs 44a, 44b which are positioned towards the lower part of the cover 43 when engaged with the cradle 1, and extend through the shield 45. A joining member 54a extends orthogonally from the rear of the top edge of the shield 45. A flange 54b extends orthogonally from the top edge of the joining member 45a and parallel to the shield 45 so that the shield 45, joining member 54a and flange 54b define a C-section 54.

When the hinges 50a, 50b are engaged with the rear top corners 52a, 52b, the cover 43 moves about the hinges 50a, 50b so that the C-section 54 can slide into place to embrace the top of the docking cradle 1 and display unit 10. In this arrangement, the shield 45 protects the docking cradle 1 and display unit 10 from the ingress of water or sand, for example. To ensure that the cover 43 remains in place, the first and second lockable press studs 44a, 44b snap closed with complementary studs (not shown) provided on the front of the base 4. For added security, a hook and loop fastener 46 is provided on opposing faces of the shield 45 and cradle 1.

An impact cushion 48 is positioned at the top of the front face of the shield 45 and extends across the width of the shield 45. The impact cushion 48 is made from a soft durable energy-dispersing material such as foam and provides impact protection such that when the docking cradle 1 is vehicle-mounted, using a mounting plate 56, the impact cushion 48 mitigates the risk of injury to the user when the vehicle is in motion. This is particularly important where the docking cradle 1 is console-mounted within a high-speed boat.

When not mounted to a vehicle or console and instead carried in a user's hands, first and second grip formations 60a, 60b, shown in FIG. 4a, help prevent the docking cradle 1 from slipping from the user's hands, for example in wet conditions. Heating pads (not shown) are built into the grips 60a, 60b and arms 2a, 2b to warm the hands of the user when operating the docking cradle 1.

In a third embodiment of the invention, shown in FIG. 9, the base flange 5 is relatively deep when compared to the first and second embodiments of the invention. This provides further protection to the display unit 10 and further reduces the risk of the display unit 10 inadvertently disengaging with the docking cradle 1. To enable access to a power switch 70 of the display unit 10 when engaged with the docking cradle 1, a recess 72 is provided in the base flange 5 and aligned with the power switch 70 when the display unit 10 is engaged with the docking cradle 1. This allows the display unit 10 to be powered up or down independently of the docking cradle 1, when the display unit 10 is engaged with the cradle 1.

Battery packs are built into the arms 2a, 2b of the docking cradle 1, which can provide power to the cradle 1 and display unit 10 when power supplied by the power socket 23 is disconnected.

It will be appreciated by the skilled person that the above embodiments may be combined in various ways without departing from the spirit and scope of the invention.

The present invention may be embodied in other specific forms without departing from its essential attributes. Accordingly, reference should be made to the appended claims and other general statements herein rather than to the foregoing specific description as indicating the scope of the invention.

1. A portable protective docking cradle engageable with an electronic display device, the cradle comprising:
an interface enabling data communication with the device; and
control elements for operating the device via the interface;
wherein the cradle is shaped to embrace the device in a docking bay, the docking bay being defined by arms of the cradle that are spaced to enable viewing of a display of the device.

2. The docking cradle of claim 1, wherein the arms are joined by a base.

3. The docking cradle of claim 2, wherein the arms and the base define a U-shaped docking bay.

4. The docking cradle of claim 2, wherein the arms extend substantially orthogonally from the base.

5. The docking cradle of claim 2, wherein the base comprises at least one electrical connector facing the docking bay for engagement with a complementary connector of the device to create the interface.

6. The docking cradle of claim 2, wherein the arms and the base are in substantially coplanar relation.

7. The docking cradle of claim 2, wherein the base comprises a lower retaining member for retaining the device in the docking bay.

8. The docking cradle of claim 7, wherein the lower retaining member is a flange that extends upwardly from the base.

9. The docking cradle of claim 8, wherein the flange comprises at least one recess for enabling access to one or more control elements of the device when the device is engaged with the cradle.

10. The docking cradle of claim 1, wherein the data communication is wireless.

11. The docking cradle of claim 1, wherein opposed inner faces of the arms are mutually parallel.

12. The docking cradle of claim 11, wherein the inner faces of the arms have formations for sliding engagement with opposed edges of the device.

13. The docking cradle of claim 1, further comprising securing means for securing the device in the docking bay.

14. The docking cradle of claim 13, wherein the securing means comprises a strap which spans the arms of the cradle.

15. The docking cradle of claim 14, wherein the strap extends across a top face of the device when the device is engaged with the cradle.

16. The docking cradle of claim 14, wherein the strap is cooperable with first and second lateral members positioned on the arms of the cradle.

17. The docking cradle of claim 14, wherein the strap is secured with a ladderlock.

18. The docking cradle of claim 14, wherein the strap is secured with a hook and loop fastener.

19. The docking cradle of claim 1, further comprising a screen which is arranged in register with the display of the device when the device is engaged with the cradle.

20. The docking cradle of claim 19, wherein the screen is compatible with the use of night vision goggles.

21. The docking cradle of claim 20, wherein the screen is arranged to filter light from the display.

22. The docking cradle of claim 19, wherein the screen is polarised to reduce glare from the screen.

23. The docking cradle of claim 19, wherein the screen is slidable relative to the cradle into register with the display.

24. The docking cradle of claim 1, further comprising a protective cover.

25. The docking cradle of claim 24, wherein the protective cover comprises a connecting member engageable with the cradle.

26. The docking cradle of claim 25, wherein the connecting member is engageable with at least one edge of the cradle.

27. The docking cradle of claim 26, wherein the connecting member and the at least one edge of the cradle engage to form a hinge.

28. The docking cradle of claim 24, wherein the protective cover comprises fixing means to fix the cover to the cradle.

29. The docking cradle of claim 24, wherein the protective cover comprises impact cushioning material.

30. The docking cradle of claim 29, wherein the impact cushioning material is arranged along a top face of the cradle.

31. The docking cradle of claim 29, wherein the impact cushioning material comprises impact absorbing foam.

32. The docking cradle of claim 1, wherein the arms comprise at least one supporting formation for supporting the device in the docking bay.

33. The docking cradle of claim 1, wherein the arms comprise a side retaining arrangement for retaining the device in the docking bay.

34. The docking cradle of claim 33, wherein the side retaining arrangement extends from at least one inside face of the arms of the cradle.

35. The docking cradle of claim 33, wherein the side retaining arrangement comprises at least one flange.

36. The docking cradle of claim 1, further comprising ports for enabling external communication with, and delivery of power to, the device.

37. The docking cradle of claim 1, wherein the control elements comprise one or more soft key buttons.

38. The docking cradle of claim 1, wherein the control elements comprise a cursor control pad.

39. The docking cradle of claim 1, wherein the control elements are positioned adjacent to the display of the device when the display is engaged with the cradle.

40. The docking cradle of claim 1, wherein the control elements are positioned on the arms of the device.

41. The docking cradle of claim 1, wherein at least some of the control elements are fabricated as a strip.

42. The docking cradle of claim 1, further comprising grip formations.

43. The docking cradle of claim 42, wherein the grip formations are provided on the arms.

44. The docking cradle of claim 42, wherein the grip formations comprise at least one plurality of concave recesses arranged in series.

45. The docking cradle of claim 42, wherein the grip formations are arranged on the outermost sides of the arms.

46. The docking cradle of claim 42, wherein the grip formations are heated.

47. The docking cradle of claim 1, further comprising an internal power supply.

48. In combination, an electronic display device and a docking cradle of claim 1.

49. The combination of claim 48, wherein the device is substantially cuboidal.

50. The combination of claim 48, wherein the cradle has grip formations arranged adjacent to the side faces of the device.

51. The combination of claim 48, wherein side edges of the device are slidingly engageable with the arms.

52. The combination of claim 51, wherein the electronic display device and the docking cradle comprise at least one tongue and groove to enable sliding engagement.

53. The combination of claim 48, wherein the cradle has a base and a further edge of the device comprises at least one electrical connector engageable with a complementary connector of the base.

54. The combination of claim 48, wherein the device is a laptop computer.

55. The combination of claim 48, wherein the device is a tablet computer.

56. A vehicle in which a portable docking cradle according to claim 1 is mounted.

57. (canceled)

58. (canceled)

59. A vehicle in which a combination according to claim 48 is mounted.

60. A portable docking cradle engageable with an electronic display device, and arranged to resist the ingress of sand, moisture and other contaminants when engaged with the device, wherein the cradle is shaped to embrace the device in a docking bay defined by:
arms that are spaced to enable viewing of a display of the device, which comprise a side retaining arrangement; and
a base which joins the arms and which comprises a lower retaining member; the cradle comprising:
an interface enabling data communication with the device; and
control elements for operating the device via the interface;
wherein the control elements are positioned on the arms of the cradle and adjacent to the display of the device when the device is engaged with the cradle.
